(19) United States
(12) Patent Application Publication
(10) Pub. No.: US 2022/0191159 A1
(43) Pub. Date: Jun. 16, 2022

(54) DEVICE AND METHOD FOR GENERATING AN ELECTRONIC CARD

(71) Applicant: Wonders.ai Inc., Taipei City (TW)

(72) Inventor: Michael Chun-Ta LIN, Taipei City (TW)

(21) Appl. No.: 17/124,702

(22) Filed: Dec. 17, 2020

(30) Foreign Application Priority Data
Dec. 15, 2020 (TW) 109144332

(51) Int. Cl. H04L 12/58; G06N 20/00; G06T 19/00; G06T 19/20

(52) U.S. Cl. CPC H04L 51/10; G06T 19/20; G06T 19/006; G06N 20/00

(57) ABSTRACT

An electronic-card generating device stores profile data of a sender and character data of a virtual character corresponding to the sender. The electronic-card generating device decides an interaction mode of the virtual character according to the profile data of the sender and the character data of the virtual character, and generates an interactive electronic card according to the interaction mode of the virtual character. The interaction mode is a mixed-reality (MR) interaction mode or an augmented-reality (AR) interaction mode. The electronic-card generating device further transmits the interactive electronic card to a recipient device such that a recipient interacts with the virtual character through the interaction mode in an MR environment or an AR environment constructed by the recipient device.

### CROSS REFERENCE TO PRIOR APPLICATIONS

The present invention claims priority under 35 U.S.C. § 119 to Taiwanese Application No. 109144332 filed Dec. 15, 2020, the entire content of which is incorporated herein by reference

### FIELD OF THE INVENTION

The present disclosure relates to a card-generating device and a card-generating method. More specifically, the present disclosure relates to an electronic-card generating device and an electronic-card generating method.

### DESCRIPTION OF THE RELATED ART

Traditional electronic cards (also known as e-cards) are “passive”, which means they can only provide regular contents (e.g., text, sound, and/or images) to a recipient, but cannot provide a mechanism for direct interaction with the recipient. In view of this, it is needed in the art to solve the technical problem of how to generate an “active” electronic card with the above-mentioned interactive mechanism.

### CONTENTS OF THE INVENTION

To solve at least the above-mentioned problem, the present disclosure provides an electronic-card generating device. The electronic-card generating device may comprise a storage, a processor and a transceiver. The processor may be electronically connected with the storage and the transceiver. The storage may be configured to store profile data of a sender and character data of a virtual character corresponding to the sender. The processor may be configured to decide an interaction mode of the virtual character according to the profile data of the sender and the character data of the virtual character, and generate an interactive electronic card according to the interaction mode of the virtual character. The interaction mode may be a mixed-reality (MR) interaction mode or an augmented-reality (AR) interaction mode. The transceiver may be configured to transmit the interactive electronic card to a recipient device such that a recipient interacts with the virtual character through the interaction mode in an MR environment or an AR environment constructed by the recipient device.

To solve at least the above-mentioned problem, the present disclosure further provides an electronic-card generating method. The electronic-card generating method may be executed by an electronic-card generating device which may store profile data of a sender and character data of a virtual character corresponding to the sender. The electronic-card generating method may comprise following steps:

deciding an interaction mode of the virtual character according to the profile data of the sender and the character data of the virtual character;

generating an interactive electronic card according to the interaction mode of the virtual character, wherein the interaction mode is a mixed-reality interaction mode or an augmented-reality interaction mode; and

transmitting the interactive electronic card to a recipient device such that a recipient interacts with the virtual character through the interaction mode in an MR environment or an AR environment constructed by the recipient device.

In summary, the electronic-card generating device and the electronic-card generating method provided by the present disclosure can generate interactive electronic cards that provide a mechanism of directly interacting with the recipient, and thus effectively solve the above-mentioned problem in the art. In addition, through the electronic-card generating device and the electronic-card generating method provided by the present disclosure, the recipient may directly interact with the virtual characters in the interactive electronic card in an MR environment or an AR environment, and such an interactive mechanism vastly enriches interactive experience of the recipient.

What have described above is not intended to limit the present disclosure, but merely outlines the solvable technical problems, the usable technical means, and the achievable technical effects for a person having ordinary skill in the art to preliminarily understand the present disclosure. According to the attached drawings and the following detailed description, a person having ordinary skill in the art can further understand the details of various embodiments of the present disclosure.

### BRIEF DESCRIPTION OF THE DRAWINGS

The drawings are provided for describing various embodiments, in which:

FIG. 1 schematically depicts an electronic-card generating device according to one or more embodiments of the present disclosure.

FIG. 2 schematically depicts an electronic card service system in an electronic-card generating device according to one or more embodiments of the present disclosure.

FIG. 3 schematically depicts an electronic-card generating method according to one or more embodiments of the present disclosure.

### DESCRIPTION OF EMBODIMENTS

In the following description, the present disclosure will be described with reference to embodiments thereof. However, these embodiments are not intended to limit the present disclosure to any operations, environment, applications, structures, processes, or steps described in these embodiments. For ease of description, contents unrelated to the embodiments of the present disclosure or contents that shall be appreciated without particular description are omitted from depiction, and dimensions of elements and proportional relationships among individual elements in the attached drawings are only exemplary examples but not intended to limit the scope of the claimed invention. Unless stated particularly, same (or similar) reference numerals may correspond to same (or similar) elements in the following description. Unless otherwise specified, the quantity of each element described below may be one or more. Terms used in this disclosure are only used to describe the embodiments, and are not intended to limit the scope of the claimed invention. Unless the context clearly indicates otherwise, singular forms “a” and “an” are intended to comprise the plural forms as well. Terms such as “comprising” and “including” indicate the presence of stated features, integers, steps, operations, elements and/or components, but do not exclude the presence of one or more other features, integers, steps, operations, elements, components and/or combinations thereof. The term “and/or” comprises any and all combinations of one or more associated listed items.

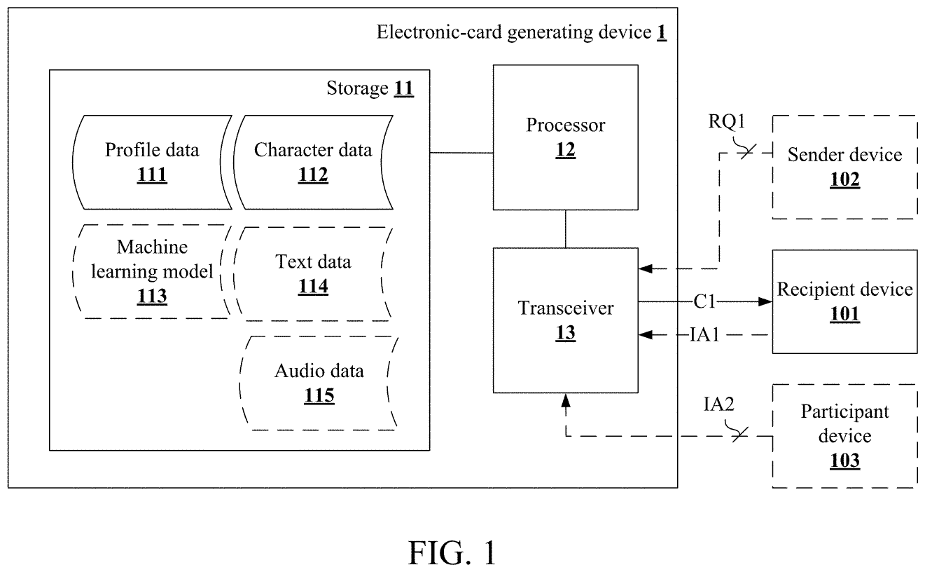

FIG. 1 schematically depicts an electronic-card generating device according to one or more embodiments of the present disclosure. The content shown in FIG. 1 is only for depicting the embodiments of the present disclosure, instead of limiting the scope of the claimed invention.

Referring to FIG. 1, an electronic-card generating device 1 may basically comprise a storage 11, a processor 12, and a transceiver 13, and the processor 12 may be electrically connected with the storage 11 and the transceiver 13. It should be noted that the electrical connection between the aforementioned components may be direct (i.e., connected with each other without any functional components therebetween) or indirect (i.e., connected with each other through other functional components). The electronic-card generating device 1 may be various electronic devices with computing capabilities, such as but not limited to: desktop computers, portable computers, smart phones, portable electronic accessories (e.g., glasses, watches, etc.)

The storage 11 may be configured to store data generated by the electronic-card generating device 1, data transmitted by external devices and/or data input by a user. The storage 11 may comprise a first-level memory (which is also called a main memory or internal memory), and the processor 12 may directly read instruction sets stored in the first-level memory, and execute these instruction sets if needed. The storage 11 may optionally comprise a second-level memory (which is also called an external memory or secondary memory), and the second-level memory may use a data buffer to transmit data stored to the first-level memory. For example, the second-level memory may be a hard disk, an optical disk or the like, without being limited thereto. The storage 11 may optionally comprise a third-level memory, such as Plug-and-Play storage or cloud storage.

The processor 12 may be any of various microprocessors or microcontrollers capable of signal processing. The microprocessor or the microcontroller is a kind of programmable special integrated circuit that has the functions of operation, storage, output/input or the like. Moreover, the microprocessor or the microcontroller can accept and process various coded instructions, thereby performing various logical operations and arithmetical operations, and outputting corresponding operation results. The processor 12 may be programmed to interpret various instructions so as to process the data in the electronic-card generating device 1 and execute various operational programs or applications.

The transceiver 13 may be configured to perform wired or wireless communication with other devices outside. Taking wireless communication as an example, the transceiver 13 may comprise, but is not limited to, an antenna, an amplifier, a modulator, a demodulator, a detector, an analog-to-digital converter, a digital-to-analog converter or other communication elements. Taking wired communication as an example, the transceiver 13 may be, for example but not limited to, a gigabit Ethernet transceiver, a gigabit Ethernet interface converter (GBIC), a small form-factor pluggable (SFP) transceiver, a ten gigabit small form-factor pluggable (XFP) transceiver, or the like.

The electronic-card generating device 1 may be used to generate and transmit an interactive electronic card C1 that is based on MR or AR to a recipient device 101, so that a recipient may open (i.e., execute) the interactive electronic card C1 through the recipient device 101 and directly interacts with a virtual character in the interactive electronic-card C1 in an MR environment or an AR environment constructed by the recipient device 101. The content of the interactive electronic card C1 may comprise the virtual character along with the corresponding actions, text, audio, background, and response to recipient's feedback. The virtual character may be a virtual human character, a cartoon character, an animal or an anthropomorphic object in an MR environment or an AR environment. For example, the anthropomorphic object may be, but not limited to: a car, a food or the like with human facial features and/or limbs, so it can imitate human expressions and behaviors.

The virtual character may be associated with a sender of the interactive electronic card C1. For example, in some embodiments, the appearance, name, species and other characteristics of the virtual character may be determined by the sender. In addition, in some embodiments, the virtual character may also have an independent personality. In view of this, the storage 11 may be configured to store character data 112 of the virtual character corresponding to the sender. Specifically, the character data 112 may comprise some parameters corresponding to the virtual character such as: appearance parameters, name parameters, species parameters, personality parameters, and the sender may determine the above-mentioned characteristics of the virtual character according to these parameters.

In addition to the character data 112, the storage 11 may be further configured to store profile data 111 of the sender. The profile data 111 may comprise, for example, but not limited to, the sender's identity information, a plurality of personality parameters, and so on. In some embodiments, the profile data 111 may also comprise membership of the sender, so that the service provider (e.g., the electronic-card generating device 1 itself) may determine the authority of the sender for adjusting the content (e.g., text, music, images, character data 112, etc.) of the card based on the membership.

The aforementioned personality parameters of the virtual character and the personality parameters of the sender may be determined based on, for example, but not limited to, the Big-Five personality traits (i.e., openness to experience, conscientiousness, extroversion, agreeableness, and neuroticism) commonly found in the field of modern psychology.

In some embodiments, in addition to the profile data 111 and the character data 112, the storage 11 may be further configured to store profile data of other users and/or character data of other virtual characters. In other words, the storage 11 may record profile data of multiple users, and may also record character data of multiple different virtual characters to further form a character database.

The processor 12 may be configured to determine an interaction mode of the virtual character based on the profile data 111 of the sender and the character data 112 of the virtual character, and the interaction mode may be an MR interaction mode or an AR interaction mode. For example, according to the personality parameters of the virtual character and/or the membership parameters of the sender, the processor 12 may determine the speech tone, facial expressions, body movements and other actions of the virtual character when the content of the interactive electronic card C1 is presented in an MR environment or an AR environment. In addition, according to the personality parameters of the virtual character and/or the membership parameters of the sender, the processor 12 may determine the reaction (e.g., falling down, being mad, making a specific sound, etc.) of the virtual character after receiving the feedback (e.g., making punches in the MR or the AR environment) from the recipient, and/or games (e.g., rock-paper-scissors) that the virtual character can play with the recipient of the interactive electronic card C1, and other interaction, and the interaction mode determined by the processor 12 may comprise the parameters and/or functions related to the above-mentioned content. In other words, character data of different virtual characters, even profile data of different senders, may affect the state and reaction of the virtual character to a certain extent when the card content is presented.

In some embodiments, the processor 12 may determine the interaction mode according to at least one interaction setting instruction (not shown in the drawings) provided by the sender for generating the interactive electronic card C1. The at least one interaction setting instruction may be received by the transceiver 13 from a sender device 102 of the sender, or may be input to the electronic-card generating device 1 by the sender through at least one input/output element (e.g., keyboard, mouse, touch display, etc.) electrically connected with the electronic-card generating device 1. For example, the at least one interaction setting instruction may comprise a character selection instruction for selecting the virtual character from the plurality of virtual characters (if any) stored in the storage 12, and/or a behavior setting instruction for specifying the behavior (e.g., body movements, facial expressions, appearance) of the virtual character in the interactive electronic card Cl. When the transceiver 13 receives the at least one interaction setting instruction, the processor 12 may first analyze the at least one interaction setting instruction, and update the character data 112 in the storage 11 if necessary, and then determine the interaction mode according to the profile data 111 and the character data 112.

After determining the interaction mode, the processor 12 may be further configured to generate an interactive electronic card C1 according to the interaction mode of the virtual character, and the transceiver 13 may be configured to transmit the interactive electronic card C1 to the recipient device 101, so that the recipient may interact with the virtual character through the interaction mode in an MR environment or an AR environment constructed by the recipient device 101. In some embodiments, the transceiver 13 may be further configured to receive a sending request RQ1 from a sender device 102 of the sender, and the processor 12 may determine the interaction mode and generate an interactive electronic card C1 according to the sending request RQ1. In other words, in some embodiments, the electronic-card generating device 1 may be used as a server between the two user devices (i.e., the sender device 102 and the recipient device 101) to provide services such as creating, sending and receiving of an interactive electronic card. The sender device 102 and the recipient device 101 both may be electronic computing devices with computing capabilities, such as but not limited to smart phones, portable computers, portable electronic accessories such as smart glasses, etc., and may be capable of executing MR or AR applications so as to create an MR environment or an AR environment.

In some embodiments, the storage 11 may be further configured to store text data 114, and the processor 12 may be further configured to generate an interactive electronic card C1 based on both of the text data 114 and the interaction mode, so that the interactive electronic card C1 may comprise text content. In this way, the recipient device 101 may present the text data 114 in the MR environment or the AR environment constructed by itself after receiving the interactive electronic card C1. In some embodiments, the storage 11 may be further configured to store audio data 115, and the processor 12 may be further configured to generate an interactive electronic card C1 based on both of the audio data 115 and the interaction mode, so that the interactive electronic card C1 may comprise audio content. Thereby, the recipient device 101 may present the audio data 115 in the MR environment or the AR environment constructed by itself after receiving the interactive electronic card C1. In some embodiments, the processor 12 may generate the text data 114 and the audio data 115 according to a multimedia setting instruction (not shown in the drawings) which is used to specify the text, pattern, and audio and so on that appear in the interactive electronic card C1 and provided by the sender (e.g., through the sender device 102 or through the electronic-card generating device 1).

In some embodiments, the processor 12 may also create other character data corresponding to new virtual characters based on a character creation instruction (not shown in the drawings) which is used to define one or more new virtual characters and provided by the sender (e.g., through the sender device 102 or through the electronic-card generating device 1), and the storage 11 may be configured to store the other character data so as to update the character database.

In some embodiments, the storage 11 may be further configured to store a plurality of interactive electronic cards (e.g., interactive electronic card C1) generated by the processor 12, and then form a card database of interactive electronic cards, such that users may also use the existing or default interactive electronic cards of the card database to send.

In some embodiments, after the recipient device 101 opens (i.e., executes) the interactive electronic card C1 and the recipient starts to interact with the virtual character, the transceiver 13 may be further configured to receive first interaction data IA1 of interaction between the recipient and the virtual character from the recipient device 101, and the processor 12 may be further configured to adjust the character data 112 according to the first interaction data IA1. For example, the first interaction data IA1 may comprise at least one action or response (such as but not limited to: body movements, sentences, expressions, or physiological signs such as heart rate, blood pressure, sweating, etc.) of the recipient to the virtual character in the MR environment or the AR environment. In other words, the recipient device 101 may comprise one or more sensors for capturing the recipient's action or response, such as but not limited to a camera, a microphone, a heart rate sensor, a blood-pressure sensor, and so on. The processor 12 may adjust the plurality of personality parameters of the virtual character according to the first interaction data IA1 to adjust the character data 112. For example, the first interaction data IA1 may record that the recipient has performed mean physical actions with malice (e.g., punching) on the virtual character in the MR environment or the AR environment, and the processor 12 may adjust the personality parameters of that will be affected by the punching (for example, but not limited to the parameters related to “agreeableness” of the aforementioned Big-Five personality traits) according to the first interaction data IA1, and the methods for adjusting personality parameters which have been known in the field of modern psychology.

In some embodiments, the storage 11 may be further configured to store a machine learning model 113, and the processor 12 may adjust the personality parameters through the machine learning model 113. Specifically, the processor 12 may train a model based on machine learning (for example, but not limited to: convolutional neural networks (CNN), recurrent neural networks (RNN) and other deep learning networks) according to the aforementioned methods for adjusting personality parameters which are based on modern psychology, using the real-world cases of sending and receiving interactive electronic cards as test data, so as to create a machine learning model 113. In this way, the machine learning model 113 may be used to automatically adjust the personality parameters.

In some embodiments, the processor 12 may be further configured to establish a live broadcast, so that the recipient device 101 may share the interactive electronic card C1 with a participant device 103 on the live broadcast, and thereby allow a participant of the participant device 103 to interact with the virtual character through the interaction mode in a MR environment or an AR environment constructed by the participant device 103. Specifically, after receiving the interactive electronic card C1, the recipient may share his/her interaction with the virtual character with other users (i.e., the participants of the live broadcast) through the live broadcast, and even invite the participant to interact with the virtual character simultaneously. Therefore, the recipient may choose to enable the live broadcast functionality on the recipient device 101 to send a live broadcast request to the electronic-card generating device 1 through the recipient device 101 (not shown in the drawings). The transceiver 13 may be configured to receive the live broadcast request, and the processor 12 may be configured to establish the live broadcast according to the live broadcast request and the interaction mode.

After the live broadcast is established, the participant device 103 may construct another MR environment or another AR environment for the environment in which the participant device 103 itself is located, via techniques such as but not limited to three-dimensional scanning and modeling, so that the participant may watch the interaction between the recipient and the virtual character in the other MR environment or the other AR environment through the live broadcast. In some embodiments, the participant may also interact with the virtual character and/or the recipient in the other MR environment or the other AR environment. In other words, interaction between the recipient and the virtual character may be presented synchronously among the recipient device and the participant device through the live broadcast, and interaction between the participant and the virtual character may also be presented synchronously among the recipient device and the participant device through the live broadcast.

In some embodiments, through live broadcast, the transceiver 13 may be further configured to receive second interaction data IA2 of the interaction between the participant and the virtual character from the participant device 103, and the processor 12 may be further configured to adjust the character data 112 according to both of the first interaction data IA1 and the second interaction data IA2. The specific way of adjustment may be the same as the aforementioned method of adjusting the character data 112 according to the first interaction data IA1, and thus will not be repeated.

In some embodiments, the recipient seen by the participant in the other MR environment or the another AR environment constructed by the participant device 103 may be another virtual character created by the recipient device 101 through scanning the appearance (e.g., facial contour or overall appearance) of the recipient, and the storage 12 may store character data of said other virtual character.

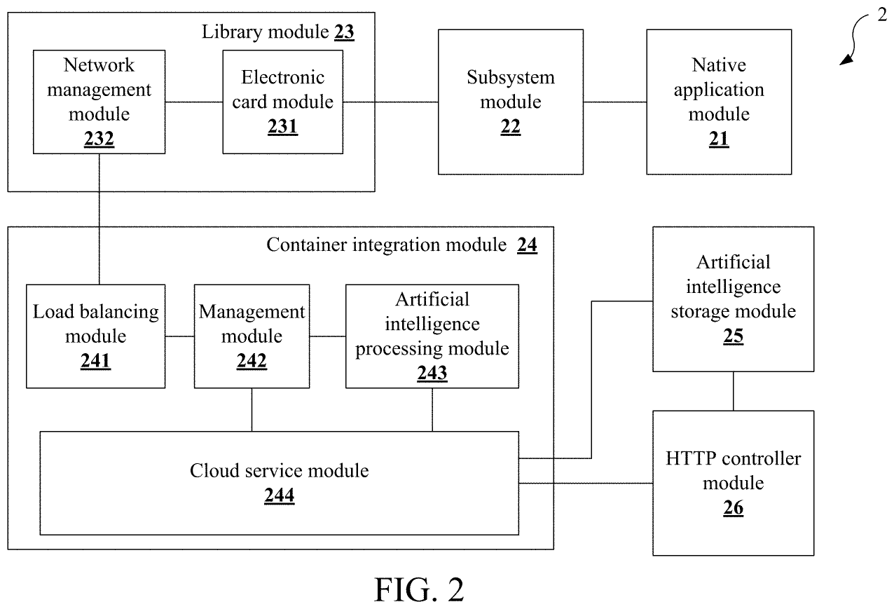

In some embodiments, the aforementioned operations of the storage 11, the processor 12, and the transceiver 13 may be based on an electronic card service system in the electronic-card generating device 1. FIG. 2 schematically depicts an electronic card service system in an electronic-card generating device according to one or more embodiments of the present disclosure. The content shown in FIG. 2 is only for depicting the embodiments of the present disclosure, instead of limiting the scope of the claimed invention.

Referring to FIG. 1 and FIG. 2 simultaneously, the electronic-card generating device 1 may comprise an electronic card service system 2, and the electronic card service system 2 may include a native application module 21, a subsystem module 22, a library module 23, a container integration module 24, an artificial intelligence storage module 25, and an HTTP controller module 26.

Since the interactive electronic card C1 is based on MR or AR, the native application module 21 may comprise parameters and/or functions related to the bottom-layer operating environment of MR or AR. More specifically, the native application module 21 may comprise MR or AR development kits, which include, for example, but not limited to, “ARKit” provided by Apple Inc., “ARCore” provided by Google Inc. or the like, so as to provide a basis for implementing functions related to MR or AR.

The subsystem module 22 may redefine the functions related to MR or AR in the native application module 21, so that the related functions may be executed on various platforms. Specifically, the subsystem module 22 may comprise parameters and/or functions (such as but not limited to the application development interface “AR Foundation” provided by “Unity”) required for executing MR-related or AR-related functions based on various development frameworks (for example, but not limited to: “Unity”, “Unreal Engine”, “Godot”, “Google Flutter”, or the like),.

The library module 23 may comprise an electronic card module 231 and a network management module 232. The electronic card module 231 may comprise parameters and/or functions required for generating, transmitting and operating the interactive electronic card C1. The network management module 232 may be used to organize and access data in and out of the library module 23.

The aforementioned functions of the electronic-card generating device 1 may be implemented in a plurality of containers, and the container integration module 24 may store corresponding parameters and functions of the plurality of containers, and may run the containers to execute the aforementioned functions of the electronic-card producing device 1. For example, the aforementioned functions of the electronic-card generating device 1 may be implemented as a plurality of “Docker” image files, and the container integration module 24 may be configured to isolate all “Docker” image files from each other so that they will not be interfered by each other when it is not necessary. In addition, the container integration module 24 may also enable the multiple “Docker” images to run on the same device at the same time.

The container integration module 24 may further comprise a load balancing module 241, a management module 242, an artificial intelligence processing module 243, and a cloud service module 244.

The load balancing module 241 may comprise at least one parameter and/or function for distributing (e.g., through scheduling) input traffic (e.g., the aforementioned sending request RQ1, the at least one interaction setting instruction, the character creation instruction, the multimedia setting instruction, or the like) to prevent the processor 12 from being overloaded.

The management module 242 may comprise a main execution program based on the programming language such as but not limited to “Golang”, and the main execution program may comprise a broadcast management function, an account management function, and a resource management function. The broadcast management function comprises at least one parameter and/or function for the aforementioned processor 12 to establish a live broadcast and for the transceiver 13 to synchronize the interaction among the virtual character, the recipient and the participant. The account management function comprises at least one parameter and/or function for the aforementioned storage 11, processor 12, and transceiver 13 to maintain (e.g., accessing, adding, deleting, adjusting, or the like) the profile data of the user (e.g., the sender, the recipient, the participant, or the like) of the interactive electronic card C1. The resource management function comprises at least one parameter and/or function for the storage 11, the processor 12, and the transceiver 13 to maintain the data stored by the user of the interactive electronic card C1.

The artificial intelligence processing module 243 may comprise at least one parameter and/or function which the storage 11, the processor 12, and the transceiver 13 needs as using the machine learning model 113. For example, the parameters and/or functions may be related to, but not limited to, “Amazon Elastic Compute Cloud (EC2)” provided by Amazon Inc.

The cloud service module 244 may include at least one parameter and/or function related to cloud network services (for example, but not limited to: “Amazon Web Service (AWS)” provided by Amazon Inc.), which may be configured to determine the data to be returned by the user and access the data of the resource management function of the access management module 242. In some embodiments, the cloud service module 244 may further comprise different types of databases according to different types of cloud service data to be stored, such as but not limited to: Relational Database Service (RDS) Database, “Redis”, “Amazon Simple Storage Service” storage bucket (i.e., AWS S3 Bucket) provided by Amazon Inc., etc. It should be understood that those with ordinary skills in the art may arbitrarily arrange and store the data related to cloud services in the electronic-card generating device 1 into each database according to the different characteristics of the various databases.

The artificial intelligence storage module 25 may comprise a machine learning model 113 and a plurality of weight values required by the machine learning model 113 to adjust the personality parameters. The HTTP controller module 26 may comprise at least one parameter and/or function required for the storage 11, the processor 12, and the transceiver 13 to implement an HTTP controller. In some embodiments, the HTTP controller module 26 may be configured to request the artificial intelligence storage module 25 to generate and provide new weight values to the cloud service module 244.

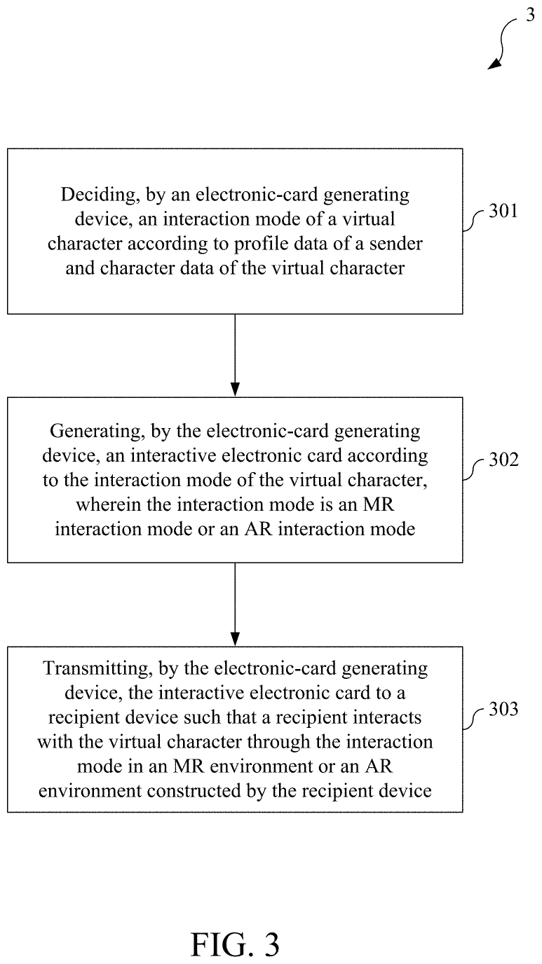

FIG. 3 schematically depicts an electronic-card generating method according to one or more embodiments of the present disclosure. The content shown in FIG. 3 is only for depicting the embodiments of the present disclosure, instead of limiting the scope of the claimed invention.

An electronic-card generating method 3 may be executed by an electronic-card generating device. The electronic-card generating device may store profile data of a sender and character data of a virtual character corresponding to the sender. The electronic-card generating method 3 may comprise following steps:

deciding an interaction mode of the virtual character by the electronic-card generating device according to the profile data of the sender and the character data of the virtual character (marked as step 301);

generating an interactive electronic card by the electronic-card generating device according to the interaction mode of the virtual character, wherein the interaction mode is a mixed-reality (MR) interaction mode or an augmented-reality (AR) interaction mode (marked as step 302); and

transmitting the interactive electronic card by the electronic-card generating device to a recipient device such that a recipient interacts with the virtual character through the interaction mode in an MR environment or an AR environment constructed by the recipient device (marked as step 303).

In some embodiments, aside from steps 301, 302 and 303, the electronic-card generating method 3 may further comprise following steps: receiving, by the electronic-card generating device, first interaction data of interaction between the recipient and the virtual character from the recipient device; and adjusting the character data according to the first interaction data. Optionally, the character data may comprise a plurality of parameters of character personality, and the electronic-card generating method 3 may further comprise following step: adjust the parameters of character personality by the electronic-card generating device according to the first interaction data, so as to adjust the character data. Optionally, the electronic-card generating device may further store a machine-learning model, and the electronic-card generating device may adjust the parameters of character personality with the machine-learning model.

In some embodiments, aside from steps 301, 302 and 303, the electronic-card generating method 3 may further comprise following step: receiving, by the electronic-card generating device, a sending request from a sender device of the sender. The electronic-card generating device may decide the interaction mode and generate the interactive electronic card according to the sending request.

In some embodiments, the electronic-card generating device may further store audio data, and the electronic-card generating method 3 may further comprise following step: generating the interactive electronic card by the electronic-card generating device according to the audio data in addition to the interaction mode such that the recipient device presents the audio data in the MR environment or the AR environment.

In some embodiments, the electronic-card generating may further store text data, and the electronic-card generating method 3 may further comprise following step: generating the interactive electronic card by the electronic-card generating device according to the text data in addition to the interaction mode such that the recipient device presents the text data in the MR environment or the AR environment.

In some embodiments, aside from steps 301, 302 and 303, the electronic-card generating method 3 may further comprise following step: establishing a live broadcast by the electronic-card generating device such that the recipient device shares the interactive electronic card with a participant device through the live broadcast, and such that a participant interacts with the virtual character in an MR environment or an AR environment constructed by the participant device. Optionally, interaction between the recipient and the virtual character may be presented synchronously among the recipient device and the participant device through the live broadcast, and interaction between the participant and the virtual character may also be presented synchronously among the recipient device and the participant device through the live broadcast. Optionally, the electronic-card generating method 3 may further comprise following steps: receiving, by the electronic-card generating device, first interaction data of the interaction between the recipient and the virtual character from the recipient device; receiving, by the electronic-card generating device, second interaction data of the interaction between the participant and the virtual character from the participant device; and adjusting the character data by the electronic-card generating device according to the second interaction data in addition to the first interaction data.

Each embodiment of the electronic-card generating method 3 basically corresponds to a certain embodiment of the electronic-card generating device 1. Therefore, people having ordinary skill in the art shall fully understand and can implement all corresponding embodiments of the electronic-card generating method 3 simply by referring to the above description for the embodiments of the electronic-card generating device 1, even if not all of the embodiments of the electronic-card generating method 3 are described in detail above.

The above disclosure is related to the detailed technical contents and inventive features thereof for some embodiments of the present invention, but such disclosure is not to limit the present invention. A person having ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

### BRIEF DESCRIPTION OF REFERENCE NUMERALS

The reference numerals are listed as follows:
1: electronic-card generating device
101: recipient device
102: sender device
103: participant device
11: storage
111: profile data
112: character data
113: machine learning model
114: text data
115: audio data
12: processor
13: transceiver
2: electronic card service system
21: native application module
22: subsystem module
23: library module
231: electronic card module
232: network management module
24: container integration module
241: load balancing module
242: management module
243: artificial intelligence processing module
244: cloud service module
25: artificial intelligence storage module
26: HTTP controller module
3: electronic-card generating method
301, 302, 303: step
CI: interactive electronic card
IA1: first interaction data
IA2: second interaction data
RQ1: sending request

1. An electronic-card generating device, comprising:
a storage, being configured to store at least one personality parameter of a sender and at least one parameter of character personality of a virtual character corresponding to the sender;
a processor, being electrically connected with the storage and configured to decide an interaction mode of the virtual character according to the at least one personality parameter of the sender and the at least one parameter of character personality of the virtual character, and generate an interactive electronic card according to the interaction mode of the virtual character, wherein the interaction mode is a mixed-reality (MR) interaction mode or an augmented-reality (AR) interaction mode; and
a transceiver, being electrically connected with the processor and configured to transmit the interactive electronic card to a recipient device such that a recipient interacts with the virtual character through the interaction mode in an MR environment or an AR environment constructed by the recipient device.

2. The electronic-card generating device of claim 1, wherein the transceiver is further configured to receive first interaction data of interaction between the recipient and the virtual character from the recipient device, and the processor is further configured to adjust the at least one parameter of character personality according to the first interaction data.

3. The electronic-card generating device of claim 2, wherein the processor is further configured to adjust the at least one parameter of character personality according to the first interaction data.

4. The electronic-card generating device of claim 3, wherein the storage is further configured to store a machine-learning model, and the processor adjusts the parameters of character personality with the machine-learning model.

5. The electronic-card generating device of claim 1, wherein the transceiver is further configured to receive a sending request from a sender device of the sender, and the processor decides the interaction mode and generates the interactive electronic card according to the sending request.

6. The electronic-card generating device of claim 1, wherein the storage is further configured to store audio data, and the processor is further configured to generate the interactive electronic card according to the audio data in addition to the interaction mode such that the recipient device presents the audio data in the MR environment or the AR environment.

7. The electronic-card generating device of claim 1, wherein the storage is further configured to store text data, and the processor is further configured to generate the interactive electronic card according to the text data in addition to the interaction mode such that the recipient device presents the text data in the MR environment or the AR environment.

8. The electronic-card generating device of claim 1, wherein the processor is further configured to establish a live broadcast such that the recipient device shares the interactive electronic card with a participant device through the live broadcast, and such that a participant interacts with the virtual character in an MR environment or an AR environment constructed by the participant device.

9. The electronic-card generating device of claim 8, wherein interaction between the recipient and the virtual character is presented synchronously among the recipient device and the participant device through the live broadcast, and interaction between the participant and the virtual character is also presented synchronously among the recipient device and the participant device through the live broadcast.

10. The electronic-card generating device of claim 9, wherein the transceiver is further configured to receive first interaction data of the interaction between the recipient and the virtual character from the recipient device and receive second interaction data of the interaction between the participant and the virtual character from the participant device, and the processor is further configured to adjust the at least one parameter of character personality according to the second interaction data in addition to the first interaction data.

11. An electronic-card generating method, being executed by an electronic-card generating device which stores at least one personality parameter of a sender and at least one parameter of character personality of a virtual character corresponding to the sender, and comprising following steps:
deciding an interaction mode of the virtual character according to the at least one personality parameter of the sender and the at least one parameter of character personality of the virtual character;
generating an interactive electronic card according to the interaction mode of the virtual character, wherein the interaction mode is a mixed-reality (MR) interaction mode or an augmented-reality (AR) interaction mode; and
transmitting the interactive electronic card to a recipient device such that a recipient interacts with the virtual character through the interaction mode in an MR environment or an AR environment constructed by the recipient device.

12. The electronic-card generating method of claim 11, further comprising following steps:
receiving first interaction data of interaction between the recipient and the virtual character from the recipient device; and
adjusting the at least one parameter of character personality according to the first interaction data.

13. The electronic-card generating method of claim 12, wherein the the electronic-card generating method further comprises following step:
adjusting the at least one parameter of character personality according to the first interaction data.

14. The electronic-card generating method of claim 13, wherein the electronic-card generating device further stores a machine-learning model, and the electronic-card generating device adjusts the parameters of character personality with the machine-learning model.

15. The electronic-card generating method of claim 11, further comprising following step:
receiving a sending request from a sender device of the sender;
wherein the electronic-card generating device decides the interaction mode and generates the interactive electronic card according to the sending request.

16. The electronic-card generating method of claim 11, wherein the electronic-card generating device further stores audio data, and the electronic-card generating method further comprises following step:
generating the interactive electronic card according to the audio data in addition to the interaction mode such that the recipient device presents the audio data in the MR environment or the AR environment.

17. The electronic-card generating method of claim 11, wherein the electronic-card generating further stores text data, and the electronic-card generating method further comprises following step:
generating the interactive electronic card according to the text data in addition to the interaction mode such that the recipient device presents the text data in the MR environment or the AR environment.

18. The electronic-card generating method of claim 11, further comprising following step:
establishing a live broadcast such that the recipient device shares the interactive electronic card with a participant device through the live broadcast, and such that a participant interacts with the virtual character in an MR environment or an AR environment constructed by the participant device.

19. The electronic-card generating method of claim 18, wherein interaction between the recipient and the virtual character is presented synchronously among the recipient device and the participant device through the live broadcast, and interaction between the participant and the virtual character is also presented synchronously among the recipient device and the participant device through the live broadcast.

20. The electronic-card generating method of claim 19, further comprising following steps:
receiving first interaction data of the interaction between the recipient and the virtual character from the recipient device;
receiving second interaction data of the interaction between the participant and the virtual character from the participant device; and
adjusting the at least one parameter of character personality according to the second interaction data in addition to the first interaction data.
